(19) United States
(12) Patent Application Publication
(10) Pub. No.: US 2014/0201149 A1
(43) Pub. Date: Jul. 17, 2014

(54) CONSISTENT BOOKMARK

(71) Applicant: CA, INC., Islandia, NY (US)

(72) Inventors: Xiaopin (Hector) WANG, Beijing (CN); Ran Shuai, Beijing (CN); Shisheng (Victor) Liu, Beijing (CN); Jiaolin Yang, Beijing (CN)

(73) Assignee: CA, Inc., Islandia, NY (US)

(21) Appl. No.: 13/742,591

(22) Filed: Jan. 16, 2013

(51) Int. Cl. G06F 17/30

(52) U.S. Cl. CPC G06F 17/30174
USPC 707/639

(57) ABSTRACT

A request to generate a snapshot of the master file system for replication is received. The master file system is frozen and a freeze callback function is invoked to generate a consistent point in time. The freeze callback function initiates generation of a bookmark event based on a current time. The bookmark event indicates the consistent point in time for generation of the snapshot. The freeze callback function also initiates capturing I/O events intended for the master file system in order and suspending journal flushing to data storage so as to avoid deadlock of the master file system. The freeze callback function is forwarded and used to generate the snapshot by indicating the consistent point in time to start generation of the snapshot.

### BACKGROUND

Embodiments of the present disclosure relate generally to information technology and more particularly, to file system replication.

Computer file systems have important file content that needs to be protected from various events. Some of these events may include power loss, system failure or a complete loss due to a natural disaster. Various systems have been developed to provide backup services for such file content. Replicas of file systems may be backed up to other physical locations and retrieved when necessary to accurately restore a file system. However, some replication systems can be quite disruptive to the online master file system during replication while other replication systems may require less downtime.

For example, when comparing the root directories of the master file system and a replica file system, a file system driver may have to freeze the file system in master in order to keep a stable directory structure. If there are millions of files to enumerate, the system can be frozen for several hours in certain environments. Some replication systems take snapshots of a file system, requiring much less down time. However, it is important to mark the correct point in time that a snapshot is taken and different operating systems provide different challenges for doing so.

### BRIEF SUMMARY

Systems, methods and computer program products for capturing a consistent point in time for replication of a master file system on a computer system are disclosed. According to an embodiment of the disclosure, a request to generate a snapshot of the master file system for replication is received. An instruction to halt write operations to the master file system is sent. A freeze callback function is invoked to generate a consistent point in time. The freeze callback function initiates generation of a bookmark event based on a current time, wherein the bookmark event indicates the consistent point in time for generation of the snapshot. The freeze callback function also initiates capturing file input-output (I/O) events intended for the master file system in order and suspending journal flushing to data storage so as to avoid deadlock of the master file system. The freeze callback function is forwarded. The bookmark event of the forwarded callback function is used to generate the snapshot by indicating the consistent point in time to start generation of the snapshot. The snapshot may be generated without the captured file I/O events changing volume data of the master file system during snapshot generation. In some cases, the freeze callback function may be used to ignore invocation request for unrelated snapshots. In other cases, dirty pages of the master file system may be flushed to data storage prior to freezing the master file system.

In another aspect, the master file system is unfrozen such that write operations to the master file system are no longer halted. An unfreeze callback function is invoked to initiate removing a consistent point in time bookmark flag and enabling journal flushing to data storage.

In a further aspect, the freeze callback function is registered in a super operations table, wherein invoking the freeze callback function comprises invoking the freeze callback function from the super operations table. The unfreeze callback function may also be registered in the super operations table, wherein invoking the unfreeze callback function comprises invoking the unfreeze callback function from the super operations table.

Some other embodiments are directed to related methods, systems and computer program products.

It is noted that aspects described with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the present disclosure and are incorporated in and constitute a part of this application, illustrate certain embodiment(s). In the drawings:

FIG. 1 is a block diagram of example logical and physical volumes;

FIG. 2 is a block diagram of an example system for generating a snapshot;

FIG. 3 is a block diagram of an example system for capturing a consistent point in time for replication of a master file system;

FIGS. 4-6 are flowcharts that illustrate example methods for capturing a consistent point in time for replication of a master file system; and

FIG. 7 is a block diagram of a computing device in which embodiments can be implemented.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Some replication systems take snapshots of a file system, requiring much less down time. A snapshot may refer to a copy of system configuration data at a given time. However, it is important to mark the correct point in time that a snapshot is taken and different operating systems provide different challenges. For example, a Linux® operating system will capture a consistent point in time differently than a Microsoft Windows® operating system. Different types of computer operations may be used. If a consistent point in time is not captured, the data in the snapshot may not be coherent. A snapshot needs a period of time, even a brief one, in which no file input-output (I/O) is allowed to change the volume corresponding to the snapshot.

Systems, methods and computer program products for capturing a consistent point in time for replication of a master file system are disclosed. When comparing the root directories of the master file system and a replica file system, a file system driver has to freeze the file system in master in order to keep a stable directory structure. A replication system, as described in embodiments below, can trigger a volume snapshot and capture the consistent point in time. The snapshots may be used for root directory iteration and comparison, while the consistent bookmark is the watershed point in time for snapshot generation. File input and output (I/O) events before the bookmark may be discarded while those after the bookmark are replicated and applied to the replica. Since firing up a snapshot consumes only a few seconds or less even for millions of files, the approach greatly reduces the freeze time.

The Linux® platform, for example, is an important platform for replication software to protect. Many embodiments described herein capture the consistent point in time in a replication product's file system driver when firing up a volume snapshot managed by a logical volume manager (LVM), such as an LVM in a Linux® environment.

For full system replication, this technology is important. In the beginning of running a full system scenario, the file system driver (for replication) may just forward the file I/O events to the underlying file system but not replicate them to the replica. Then, the master engine immediately triggers an LVM snapshot (crashed consistent state) for the LVM volume and synchronizes the whole volume read from the snapshot to the replica. The file system driver (for replication) has to capture the consistent point in time of the LVM snapshot coming into the life in order to replicate the file I/O changes to the replica. In other words, the master synchronizes the volume data in its LVM snapshot and replicates any changes to the file system immediately after the snapshot is taken. The consistent bookmark, representing the consistent point in time when generating a LVM snapshot, acts here as the starting point for replication.

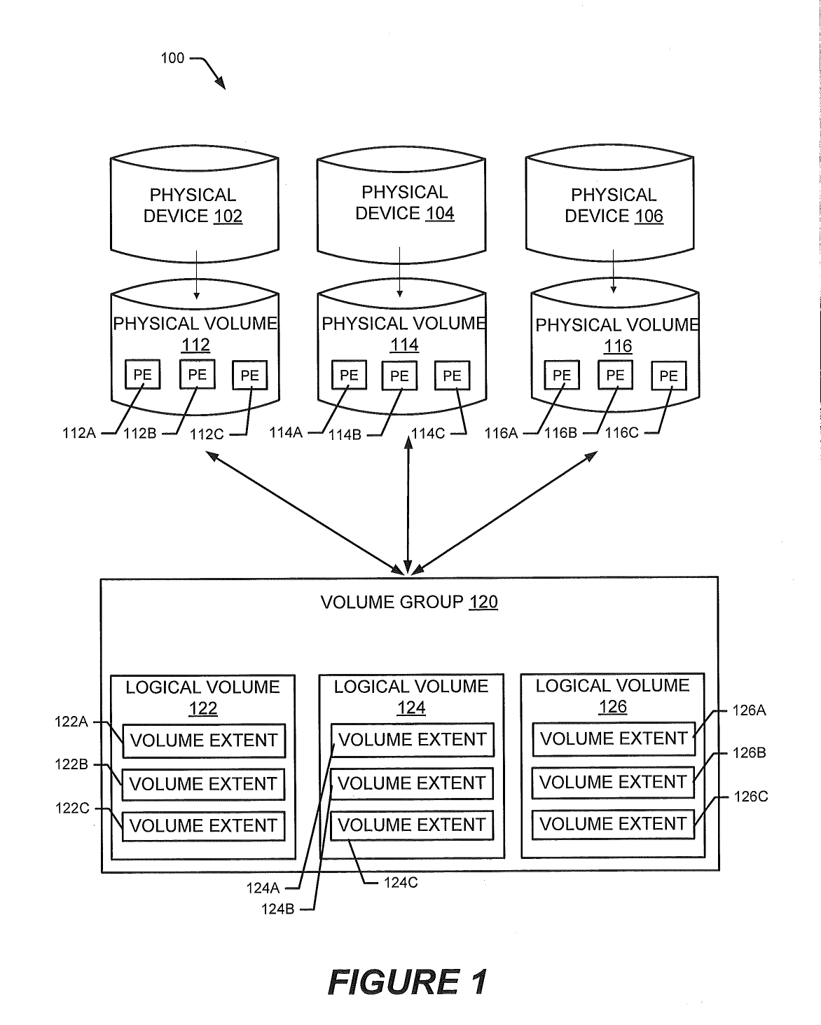

FIG. 1 illustrates an example system 100 for logical volume management. A logical volume provides storage virtualization. For example, a logical volume manager (LVM) creates an abstraction layer over physical storage that allows creation of logical storage volumes 122-124. This provides much greater flexibility than using physical storage directly with conventional partitioning systems. With logical volumes, you are not restricted to physical disk sizes of physical devices 102-106. In addition, the hardware storage configuration is hidden from the software so it can be resized and moved without stopping applications.

Physical volumes 112-116 associated with physical devices 102-106 can be hard disks, hard disk partitions, or Logical Unit Numbers (LUNs) of an external storage device. Volume management treats physical volumes 112-116 as sequences of chunks called physical extents (PEs), shown by PEs 112A-C, 114A-C and 116A-C. Some volume managers (such as in some UNIX® and Linux® operating system implementations or other LVM compatible environments) have PEs of a uniform size while others have variably-sized PEs. PEs may map one-to-one to logical volume extents 122A-C, 124A-C and 126A-C of logical volumes 122-126. In some cases, multiple PEs may map to each volume extent. Logical volumes 122-126 may be pooled together into a volume group 120.

Some volume managers may generate snapshots by applying copy-on-write to each of volume extents 122A-126C. A volume manager may copy a volume extent to a copy-on-write table just before it is written to. This preserves an old version of the logical volume—the snapshot—which systems can later reconstruct by overlaying the copy-on-write table atop the current logical volume. Snapshots can be useful for backing up self-consistent versions of volatile data or for rolling back large changes.

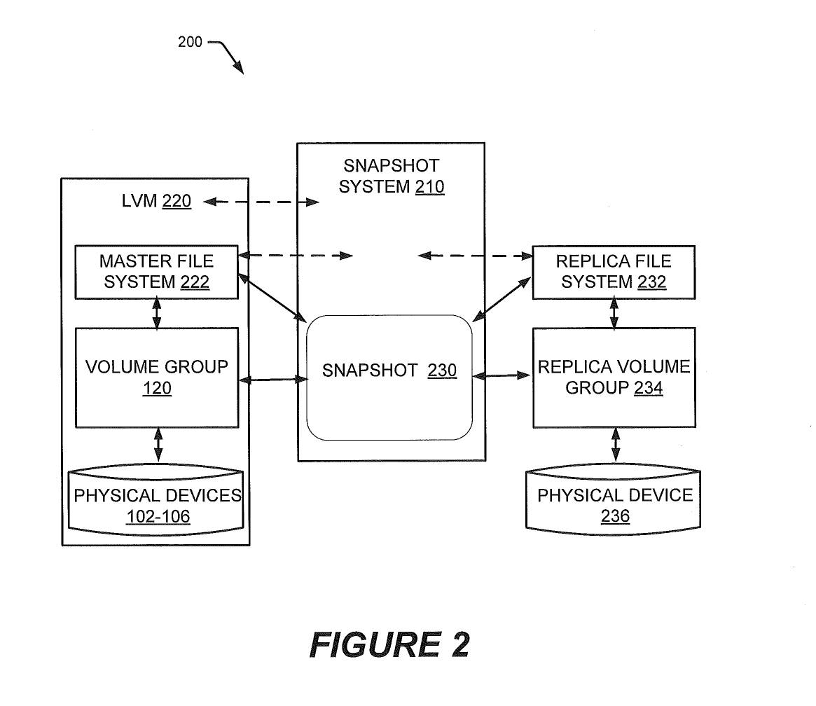

FIG. 2 illustrates a block diagram of an example system 200 for generating a snapshot, according to an embodiment. System 200 shows logical volume manager (LVM) 220, which may include master file system 222, volume group 120 and corresponding physical devices 102-106. Master file system 222 may provide a map of the files and directories in volume group 120 and help to provide the abstraction of the stored data. In many of the embodiments described herein, references to master file system 222 may include the data of volume group 120.

Snapshot system 210 may generate snapshot 230 from master file system 222 (and corresponding data from volume group 120). Snapshot 230 may be used to rollback changes or to restore master file system 222. Snapshot system 210 may store or synchronize snapshot 230 with a replica. For example, snapshot system 210 may copy snapshot 230 to replica file system 232 and corresponding replica volume group 234. Volume group 234 may correspond to physical volumes stored in physical device or devices 236. It is important that a consistent bookmark identify the consistent point in time for generation of snapshot 230.

According to an embodiment, LVM 220 may be coupled to snapshot system 210, either directly (such as within the same computing device or computer system) or indirectly over a network. Such a network may facilitate wireless or wireline communication, and may communicate using, for example, IP packets, Frame Relay frames, Asynchronous Transfer Mode (ATM) cells, voice, video, data, and other suitable information between network addresses. The network may include one or more local area networks (LANs), radio access networks (RANs), metropolitan area networks (MANS), wide area networks (WANs), all or a portion of the global computer network known as the Internet, and/or any other communication system or systems at one or more locations. Snapshot system 210 may also be coupled to replica file system 232 (and corresponding replica volume group 234), directly or indirectly over a network. The blocks of FIG. 2 are used for descriptive purposes and are not necessarily limited to the locations shown in FIG. 2. For example, snapshot system 210, or any portion or combination of components of snapshot system 210, may be a part of LVM 220, situated between LVM 220 and master file system 222, and/or situated between LVM 220 and replica file system 232.

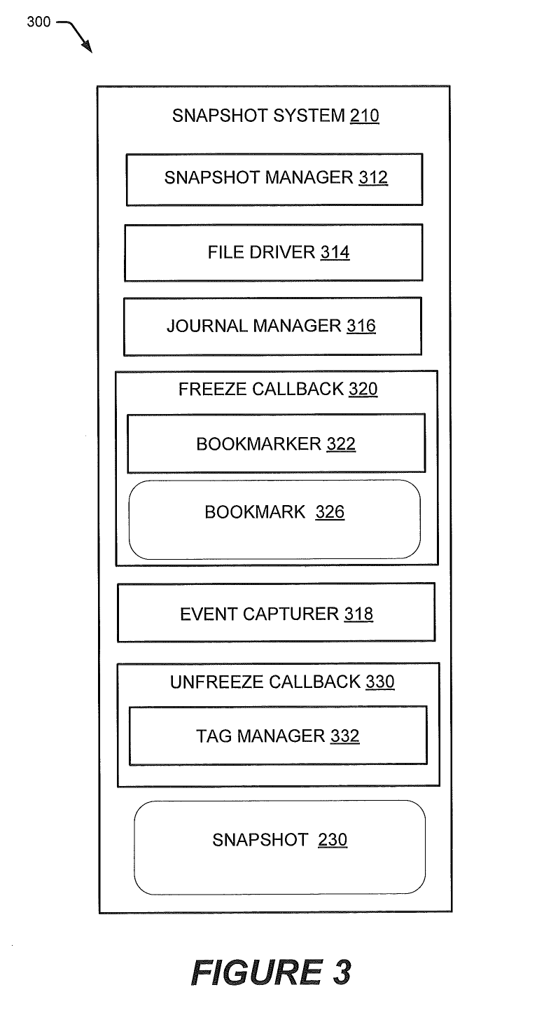

FIG. 3 illustrates system diagram 300, which shows more details of snapshot system 210, according to an embodiment. Snapshot system 210, or any combination of components of system 210, LVM 220, master file system 222 or replica file system 232, may be software, firmware, or hardware or any combination thereof in a computing device. Computing devices generally refer to any computer system capable of implementing managed machines, which may include, without limitation, a mainframe computer platform, personal computer, mobile computer (e.g., laptop, smart phone, tablet computer, navigation device), server, server farm, set-top box, wireless communication terminal (e.g., cellular data terminal), embedded system or any other appropriate program code processing hardware.

Snapshot system 210 may include snapshot manager 312 and/or file driver 314. File driver 314 may be a replication file system driver that is situated between LVM 220 and master file system 222 and processes relevant file I/O. File driver 314 may send or forward control codes to master file system 222 from LVM 220. In some cases, such control codes may be in the call stack and associated with Linux® kernel source code. In some cases, file driver 314 may also be a master file system driver.

Snapshot system 210 may invoke freeze callback 320 and unfreeze callback 330, which may be registered in a super operations table of snapshot system 210, master files system 222 and/or replication file system 232. Snapshot manager 312 and/or file driver 314 may be configured to invoke freeze callback 320 and unfreeze callback 330. In an embodiment, snapshot system 210 may exist within, be a part of, or be controlled by master file system 222 and/or replication file system 232. Snapshot system 210 may also include, represent or be a part of a replication system, backup system, or any related functionality. Snapshot system 210 is shown in FIGS. 2 and 3 for purposes of explanation and is not limited to the locations of the illustrated conceptual blocks in the block diagrams of FIGS. 2 and 3. Snapshot system 210 may also include journal manager 316, configured to enable or disable journaling or journal flushing.

Snapshot manager 312 may be configured to receive a request to generate a snapshot of the master file system, including directories and volumes, for the purposes of replication. This request may come from a master engine. Snapshot manager 312 may direct LVM 220 to freeze master file system 222. File system driver 314 may send or pass on the instruction to halt the write operations. Write operations to master file system 222 (or associated volume group 120) will be halted. This may be for a period of time. The period of time can be short. In some cases, this may involve LVM 220 issuing a DM_DEV_SUSPEND_CMD io control code with a DM_SUSPEND_FLAG flag. Master file system 222 (and maybe replica file system 232) is then frozen. In some embodiments, all of the dirty pages of master file system 222 are flushed to physical disk.

Immediately after master file system 222 is flushed, snapshot manager 312 or file system driver 314 subsequently invokes freeze callback function 320 during file system suspension. Two callbacks are registered in the super_operations table, freeze (freeze_fs) callback 320 and unfreeze (unfreeze_fs) callback 330, during mounting to the master file system's protected directories. These callback functions may be registered in the super operations table of kernel memory of both master file system 222 and replica file system 232.

A consistent bookmark 326 is generated in freeze callback function 320. Consistent bookmark 326 may reside in the file I/O event sequence. For example, consistent bookmark 326 may reside after all file I/O events before the snapshot but before all file I/O events after the snapshot generated successfully. After the virtual file system returns from the freeze callback in master file system 222 (and maybe from replica file system 232), LVM 220 generates the snapshot in a few seconds. In an embodiment, only read I/O continues, if necessary, during this period. When a replication master wants to generate consistent bookmark 326, it needs to notify this to snapshot manager 312.

Snapshot manager 312 will read any flags in freeze callback 320 to determine whether it is invoked for generating a consistent bookmark. If true, it will forward freeze callback function 320 to the underlying file system so that bookmarker 322 can record consistent bookmark 326, such as in an event buffer of freeze callback 320. Bookmarker 322 may create bookmark 326 as a bookmark event with a timestamp. The timestamp of the bookmark event represents the consistent point in time. Snapshot generation is to begin after the consistent point in time. In other embodiments, bookmark 326 may be a time value or event maintained in other ways in or by freeze callback 320.

The timestamp may be based on a current time. A current time may be a time of day. The time of day may include hours, minutes, seconds, part of a second, day, month, year, or any combination of time indicators. A current time may also be a value that is regularly incremented, such as a register value. A current time may be a stored value that accumulates value, increases or decreases. A current time is not limited to these examples and can be any time indicator.

Between the period of freeze callback 320 and unfreeze callback 330, the replication file system cannot write journals to disk in case of deadlock. Journal manager 316 may disable journal writing or journal flushing to disk (must cache them in memory). The freeze callback 320 of master file system 222 may handle its journaling mechanism for data consistency. In freeze callback 320, the replication file system needs to ensure it is called because of the snapshot request it cares for. Freeze callback 320 must ignore unrelated snapshot invoking, such as application generated snapshots other than those by the master engine.

Freeze callback 320 initiates the operations that captures bookmark 326. Freeze callback 320 also initiates capture of file I/O events. Freeze callback 320 may initiate capture of file I/O by notifying snapshot manager 312. Snapshot manager 312 may assist or utilize event capturer 318 in capturing interested file I/O. In some cases, file I/O may be captured in the event sequence buffer, which will finally flush to journal files. In other cases, file I/O may be forwarded in freeze callback 320 to the file system. In various embodiments, freeze callback 320 provides an environment for the capture of bookmark 326 and the capture of subsequent related file I/O by snapshot manager 312 or event capturer 318.

In an example, freeze callback 320 may record a point in time with bookmark 326. Freeze callback 320 may notify snapshot manager 312 to capture file I/O. A number of I/O events that occur right after that point in time may be captured. The events may be captured in order, with the first event being the bookmark event. These events may be held in freeze callback 320 or an event buffer or stack associated with freeze callback 320. In some cases, other functions may obtain bookmark 326 and the captured events.

In a further embodiment, a snapshot generation function controlled by snapshot manager 312 expects freeze callback 320 to block the related file I/O. Snapshot manager 312 generates the consistent bookmark by using the current time and forwards the callback to the underlying file system.

Now that consistent point in time bookmark 326 is captured, LVM 220 creates snapshot 230 with snapshot system 210. Snapshot 230 may be generated using known methods of snapshot generation. However, snapshot system 210 provides for a coherent snapshot based on the consistent point in time, the blocking of related file I/O and the capture of related file I/O subsequent to the consistent point in time.

Once snapshot 230 for the volume is created successfully, snapshot manager 312 directs LVM 220 to unfreeze master file system 222. LVM 220 may issue a DM_SUSPEND_FLAG io control code without DM_SUSPEND_FLAG flag. The underlying file system is thawed. Snapshot manager 312 or file driver 314 invokes unfreeze callback 330. Journal manager 316 enables journal flushing.

Unfreeze callback 330 in the super_operations table is invoked during resuming of file system I/O operations. Unfreeze callback 330 allows for snapshot manager 312 to do some wrap up work. During the file system thawing, snapshot manager 312 will use tag manager 332 to clear up the flag of consistent bookmark generation to avoid wrong generating unwanted consistent bookmark in the next freeze callback invoked by other LVM users. According to various embodiments, operations performed by snapshot manager 312 may also be performed by file driver 314.

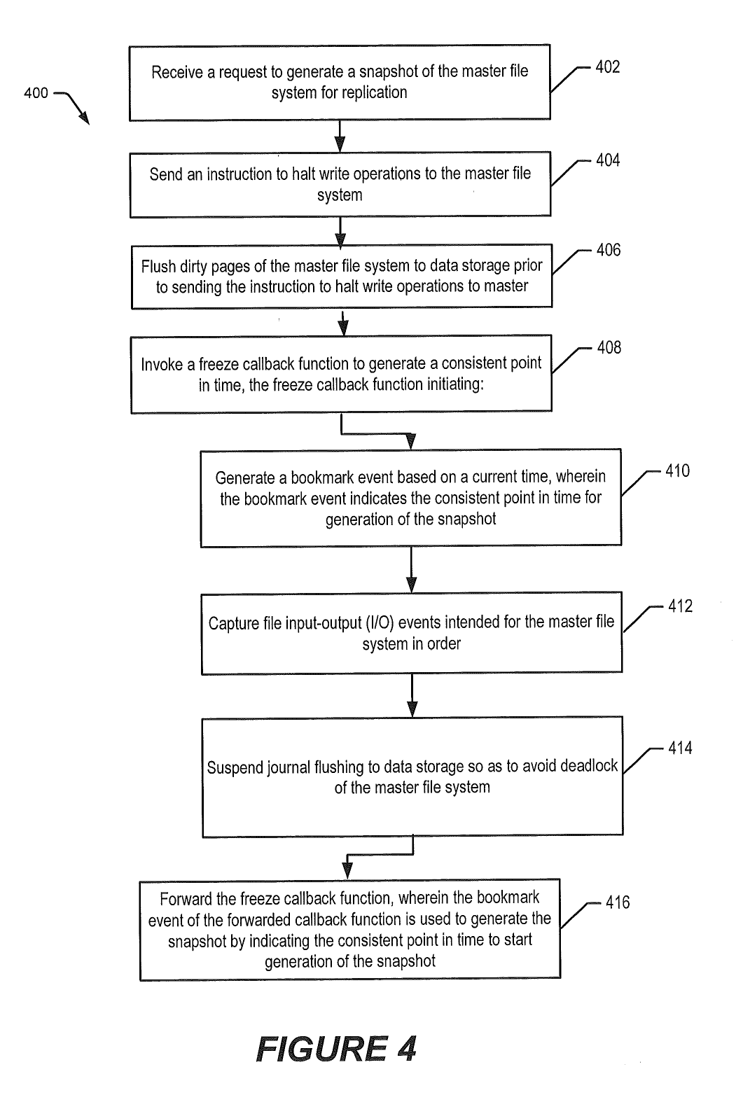

These and other more generalized operations and methods are illustrated by method 400 in the flowchart of FIG. 4, which may be performed by an embodiment of snapshot system 210. Numerical representations or other symbolic representations of the categories can be substituted. In block 402 of FIG. 4, a request to generate a snapshot of the master file system is received. Snapshot system 210 may receive the request from the master engine associated with master file system 222 and corresponding volume group 120.

An instruction to halt write operations is sent to master file system 222 (block 404 of FIG. 4). Master file system 222 is frozen such that write operations to master file system 222 (or volume group 120 of master file system 222) are halted. This may be for a period of time. In some cases, this period of time may be very short, as in 1 second or less than 10 seconds. In other cases, this period of time may be greater than 10 seconds but less than two minutes.

In some cases, dirty pages, or pages reflecting changes to the data not yet written to data storage of volume group 120, are flushed or written to disk prior to freezing master file system 222 (block 406). Once master file system 222 is frozen and flushed, freeze callback function 320 is invoked to generate a consistent point in time (block 408).

When freeze callback 320 is invoked, a few operations are initiated. A bookmark event is generated based on a current time (block 410). The bookmark event has a timestamp that indicates the consistent point in time for generation of a snapshot. Inputs and outputs intended for master file system 222 are captured (block 412). Bookmarker 322 of freeze callback 320, snapshot manager 312, file system driver 314 and/or event capturer 318 may assist snapshot system 210 with these operations.

In some cases, journal flushing to data storage may be suspended so as to avoid deadlock of master file system 222 (block 414). Journal events may include records of operations on a data volume, including files and directories. Journal manager 316 may suspend journaling. In some embodiments, journal manager 316 may be a part of freeze callback 320 and/or unfreeze callback 330. In other embodiments, journal manager 316 is part of snapshot system 210 and works in coordination with freeze callback 320 and unfreeze callback 330.

In block 416 of FIG. 4, freeze callback 320 is forwarded. Freeze callback 320 may be forwarded to the master file system 222. In other cases, freeze callback 320 may be forwarded to other functions that are managed by snapshot manager 312. The bookmark 326 event of the forwarded callback function is used to generate snapshot 230 by indicating the consistent point in time to start generation of the snapshot.

The replica engine will eventually send consistent bookmark 326 along with other captured events to replica file system 232 and corresponding replica volume group 234. Capturing consistent bookmark 326 with snapshot system 210 allows a file system to generate scheduled crashed state consistent bookmarks for recovery. System 210 dramatically reduces the system freeze time for millions of files under protection. System 210 also provides for full system live migration as well as offline migration.

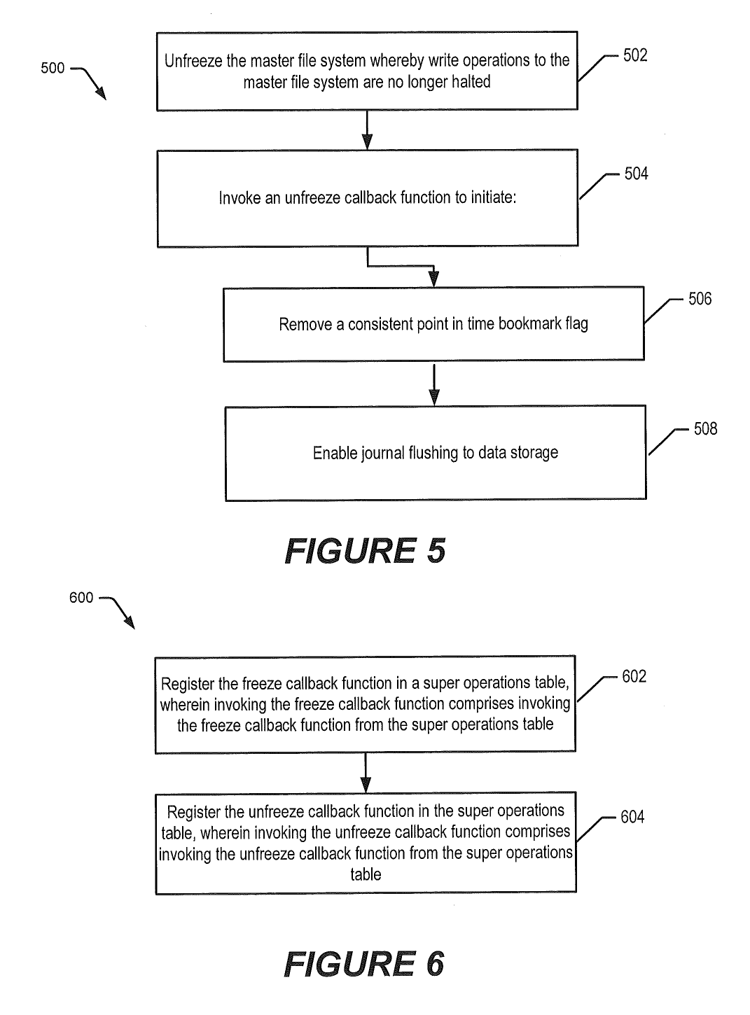

FIG. 5 illustrates example method 500 for unfreezing a file system that invoked freeze callback 320, according to an embodiment. In block 502 of FIG. 5, master file system 222 is unfrozen such that write operations to master file system 222 are no longer halted. Unfreeze callback function 330 is invoked (block 504 of FIG. 5). Unfreeze callback 330 initiates removal of a consistent point in time bookmark flag (block 506 of FIG. 5). Journal flushing to data storage is also enabled (block 508 of FIG. 5). Any journal writing that was halted may be continued.

Without freeze callback function 320 and unfreeze callback function 330, the data in snapshot 230 would not be as accurate. Snapshot creation requires some time, such as one second, during which no file I/O is allowed to change the volume data corresponding to the snapshot. Some file systems may implement freeze callback function 320 and unfreeze callback function 330 to flush its journals to disk. This may be done to ensure consistent disk structures, which may not be the same as those of the replication file system.

Freeze callback 320 and unfreeze callback 330 may be registered in a super operations table, or equivalent, as shown in the example method 600 of FIG. 6. In block 602, freeze callback function 320 is registered in a super operations table such that invoking freeze callback 320 comprises invoking freeze callback 320 from the super operations table. In block 604, unfreeze callback function 330 is registered in the super operations table such that invoking unfreeze callback 330 comprises invoking freeze callback 330 from the super operations table. The functions may be registered when mounting protected directories of master file system 222 and/or replica file system 232.

In embodiments described herein, freeze callback 320 and unfreeze callback 330 may be callback functions used in a Linux® operating system. LVM 220 and snapshot system 210 also may exist in a Linux® environment. However, in other embodiments, freeze callback 320 and unfreeze callback 330 may be called by snapshot system 210 and LVM 220, operating in another UNIX®-based or LVM compatible operating system.

In another embodiment, the functionality of system 210 may be provided through a browser on a computing device. The browser may be any commonly used browser, including any multithreading browser. System 210 may be software in a browser or software displayed by the browser. System 210 may be software hosted by a server and served to client devices over a network.

As will be appreciated by one of skill in the art, aspects of the disclosure may be embodied as a method, data processing system, and/or computer program product. Furthermore, embodiments may take the form of a computer program product on a tangible computer readable storage medium having computer program code embodied in the medium that can be executed by a computing device.

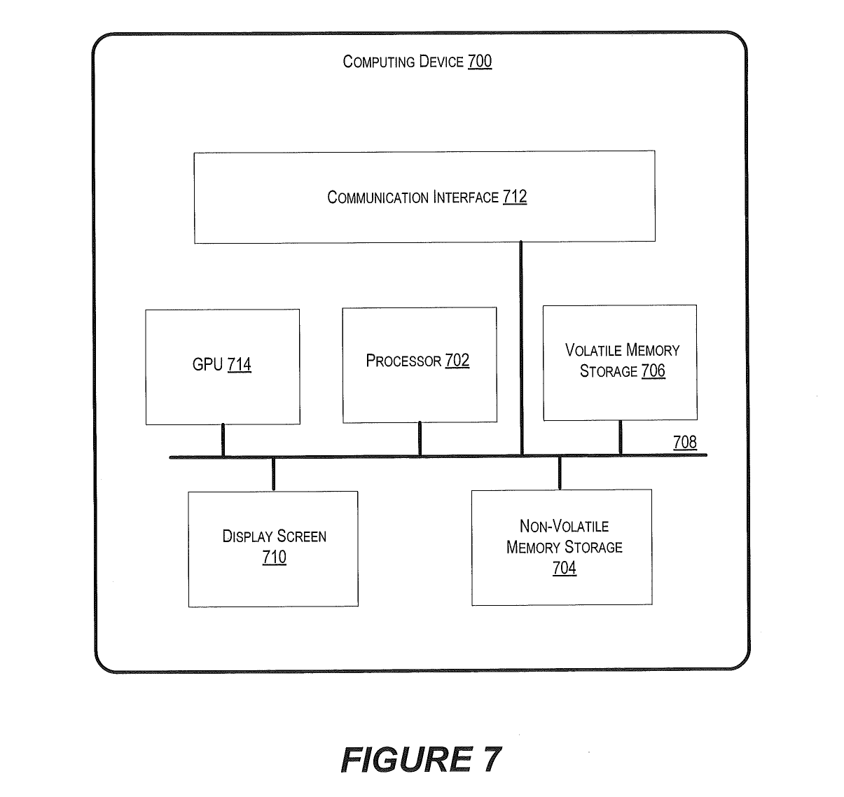

FIG. 7 is an example computer system 700 in which embodiments of the present disclosure, or portions thereof, may be implemented as computer-readable code. For example, the components of snapshot system 210, LVM 220, replica file system 232 (and corresponding replica volume 234 and physical device 236) or any other components of system 200 may be implemented in one or more computer devices 700 using hardware, software implemented with hardware, firmware, tangible computer-readable storage media having instructions stored thereon, or a combination thereof and may be implemented in one or more computer systems or other processing systems. Components and methods in FIGS. 1-6 may be embodied in any combination of hardware and software.

Computing device 700 may include one or more processors 702, one or more non-volatile storage mediums 704, one or more memory devices 706, a communication infrastructure 708, a display screen 710 and a communication interface 712. Computing device 700 may also have networking or communication controllers, input devices (keyboard, a mouse, touch screen, etc.) and output devices (printer or display).

Processor(s) 702 are configured to execute computer program code from memory devices 704 or 706 to perform at least some of the operations and methods described herein, and may be any conventional or special purpose processor, including, but not limited to, digital signal processor (DSP), field programmable gate array (FPGA), application specific integrated circuit (ASIC), and multi-core processors.

GPU 714 is a specialized processor that executes instructions and programs, selected for complex graphics and mathematical operations, in parallel.

Non-volatile storage 704 may include one or more of a hard disk drive, flash memory, and like devices that may store computer program instructions and data on computer-readable media. One or more of non-volatile storage device 704 may be a removable storage device.

Memory devices 706 may include one or more volatile memory devices such as but not limited to, random access memory. Communication infrastructure 708 may include one or more device interconnection buses such as Ethernet, Peripheral Component Interconnect (PCI), and the like.

Typically, computer instructions are executed using one or more processors 702 and can be stored in non-volatile storage medium 704 or memory devices 706.

Display screen 710 allows results of the computer operations to be displayed to a user or an application developer.

Communication interface 712 allows software and data to be transferred between computer system 700 and external devices. Communication interface 712 may include a modem, a network interface (such as an Ethernet card), a communications port, a PCMCIA slot and card, or the like. Software and data transferred via communication interface 712 may be in the form of signals, which may be electronic, electromagnetic, optical, or other signals capable of being received by communication interface 712. These signals may be provided to communication interface 712 via a communications path. The communications path carries signals and may be implemented using wire or cable, fiber optics, a phone line, a cellular phone link, an RF link or other communications channels. According to an embodiment, a host operating system functionally interconnects any computing device or hardware platform with users and is responsible for the management and coordination of activities and the sharing of the computer resources.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Aspects of the present disclosure are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described example embodiments or any actual software code with the specialized control of hardware to implement such embodiments, but should be defined only in accordance with the following claims and their equivalents.

What is claimed is:

1. A computer-implemented method comprising:
receiving a request to generate a snapshot of the master file system for replication;
sending an instruction to halt write operations to the master file system;
invoking a freeze callback function to generate a consistent point in time, the freeze callback function initiating:
generating a bookmark event based on a current time, wherein the bookmark event indicates the consistent point in time for generation of the snapshot;
capturing file input-output (I/O) events intended for the master file system in order; and
suspending journal flushing to data storage, whereby deadlock of the master file system is avoided; and
forwarding the freeze callback function, wherein the bookmark event of the freeze callback function is used to generate the snapshot by indicating the consistent point in time to start generation of the snapshot.

2. The method of claim 1, wherein the snapshot is generated without the file I/O events changing volume data of the master file system during snapshot generation.

3. The method of claim 1, further comprising using the freeze callback function to ignore invocation requests for unrelated snapshots.

4. The method of claim 1, further comprising registering the freeze callback function in a super operations table, wherein invoking the freeze callback function comprises invoking the freeze callback function from the super operations table.

5. The method of claim 1, further comprising:
unfreezing the master file system, whereby write operations to the master file system are no longer halted; and
invoking an unfreeze callback function to initiate:
removing a consistent point in time bookmark flag; and
enabling journal flushing to data storage.

6. The method of claim 5, further comprising registering the unfreeze callback function in the super operations table, wherein invoking the unfreeze callback function comprises invoking the unfreeze callback function from the super operations table.

7. The method of claim 1, further comprising flushing dirty pages of the master file system to data storage prior to the sending the instruction to halt write operations to the master file system.

8. A computer-implemented system, comprising:
a freeze callback function to generate a consistent point in time; and
a snapshot manager to:
receive a request to generate a snapshot of the master file system for replication;
send an instruction to halt write operations to the master file system; and
invoke the freeze callback function to initiate:
generating a bookmark event based on a current time, wherein the bookmark event indicates the consistent point in time for generation of the snapshot;
capturing file input-output (I/O) events intended for the master file system in order; and
suspending journal flushing to data, whereby deadlock of the master file system is avoided; and
wherein the file system driver is further configured to forward the freeze callback function, wherein the bookmark event of the freeze callback function is used to generate the snapshot by indicating the consistent point in time to start generation of the snapshot.

9. The system of claim 8, wherein the snapshot manager generates the snapshot without the file I/O events changing volume data of the master file system during snapshot generation.

10. The system of claim 8, wherein the freeze callback function is further to ignore invocation requests for unrelated snapshots.

11. The system of claim 8, wherein the file system driver is further to register the freeze callback function in a super operations table and invoke the freeze callback function from the super operations table.

12. The system of claim 8, further comprising an unfreeze callback function to unfreeze the master file system, whereby write operations to the master file system are no longer halted, and wherein the snapshot manager is further to invoke the unfreeze callback function to initiate removing a consistent point in time bookmark flag and enabling journal flushing to data storage.

13. The system of claim 12, wherein the snapshot manager is further to register the unfreeze callback function in a super operations table and invoke the unfreeze callback function from the super operations table.

14. The system of claim 8, wherein the snapshot manager is further to flush dirty pages of the master file system to data storage prior to the freezing the master file system.

15. A computer program product, comprising:
a tangible computer readable storage medium having computer readable program code embodied in the medium that when executed by a processor causes the processor to perform operations comprising:
receiving a request to generate a snapshot of the master file system for replication;
sending an instruction to halt write operations to the master file system;
invoking a freeze callback function to generate a consistent point in time, the freeze callback function initiating:
generating a bookmark event based on a current time, wherein the bookmark event indicates the consistent point in time for generation of the snapshot;
capturing file input-output (I/O) events intended for the master file system in order; and
suspending journal flushing to data storage, whereby deadlock of the master file system is avoided; and
forwarding the freeze callback function, wherein the bookmark event of the freeze callback function is used to generate the snapshot by indicating the consistent point in time to start generation of the snapshot.

16. The computer readable storage medium of claim 15, further comprising computer readable program code causing the processor to perform:
generating the snapshot without the file I/O events changing volume data of the master file system during snapshot generation.

17. The computer readable storage medium of claim 15, further comprising computer readable program code causing the processor to perform:
ignoring invocation requests for unrelated snapshots.

18. The computer readable storage medium of claim 15, further comprising computer readable program code causing the processor to perform:
unfreezing the master file system, whereby write operations to the master file system are no longer halted; and
invoking the unfreeze callback function to initiate removing a consistent point in time bookmark flag and enabling journal flushing to data storage.

19. The computer readable storage medium of claim 18, further comprising computer readable program code causing the processor to perform:
registering the freeze callback function in a super operations table;
invoking the freeze callback function from the super operations table;
registering the unfreeze callback function in a super operations table; and
invoking the unfreeze callback function from the super operations table.

20. The computer readable storage medium of claim 15, further comprising computer readable program code causing the processor to perform:
flushing dirty pages of the master file system to data storage prior to the sending an instruction to halt write operations to the master file system.
